(19) United States
(12) Patent Application Publication
(10) Pub. No.: US 2006/0154145 A1
(43) Pub. Date: Jul. 13, 2006

(54) Secondary battery having jelly roll configuration type electrode assembly

(76) Inventor: Hyung Bok Lee, Yongin-si (KR)

Correspondence Address: CHRISTIE, PARKER & HALE, LLP, PO BOX 7068, PASADENA, CA, 91109-7068, US

(21) Appl. No.: 11/236,418

(22) Filed: Sep. 26, 2005

(30) Foreign Application Priority Data
Sep. 24, 2004 (KR) 10-2004-0077236

(51) Int. Cl. H01M 2/26; H01M 2/08; H01M 2/06; H01M 10/04

(52) U.S. Cl. 429/211; 429/94; 429/161; 429/185; 29/623.1; 29/623.2

(57) ABSTRACT

A secondary battery including a jelly roll configuration type electrode assembly formed by winding a stack of two electrodes having different polarities and at least one separator for preventing a short circuit between the two electrodes, a case for containing the electrode assembly, and electrode tabs for connecting the two electrodes of the electrode assembly to an outside of the case, wherein a level for extracting the electrode tabs from the electrode assembly is substantially equal to a level for extracting the electrode tabs from the case. The electrode assembly may be formed to be a jelly roll having an elliptical shape or a track shape. In one exemplary embodiment, the electrode tabs are used in a pouch having a hollow for containing the electrode assembly in only one side. Also, the electrode tabs are extend linearly from the pouch.

### CROSS-REFERENCE TO RELATED APPLICATION

This application claims priority to and the benefit of Korean Patent Application No. 2004-0077236, filed on Sep. 24, 2004, in the Korean Intellectual Property Office, the entire contents of which is incorporated herein by reference.

### BACKGROUND OF THE INVENTION

1. Field of the Invention

The present invention relates to a secondary battery, and more particularly, to a secondary battery including a jelly roll configuration type electrode assembly having two electrodes and at least one separator for insulating the two electrodes.

2. Description of the Related Art

Recently, secondary batteries are being researched and developed in a variety of fields because of many advantages such as rechargeability, small size, and large capacity. Currently, a nickel metal-hydride (Ni-MH) battery, a lithium (Li) battery, and a lithium ion battery are available in the art.

In such secondary batteries, most of the bare cells are formed by inserting an electrode assembly in a cell container and sealing the cell container with a cover. The container may be a pouch or a metallic can made of iron, aluminum, or an aluminum alloy. An electrolyte for a secondary battery may be-a solid polymer, an electrolyte impregnated gel type polymer, or a liquid polymer in which the electrolyte ions are mixed with a solvent.

The sealed bare cell is connected to safety devices such as a positive temperature coefficient (PTC) device, a thermal fuse, and a protective circuit module (PCM) and other accessories, and then packaged in a separate case. Additionally, gaps between the bare cell and the accessories are filled or coated with a plastic resin to provide a battery appearance.

It is useful to manufacture a secondary battery capable of containing an abundant amount of electricity but having a small size and a light weight. Also, electrical energy per an hour, i.e., electric power, plays an important role in the battery application field. One way to improve electric power performance is to increase a contact area between an electrolyte and an active material. Typically, the active material is coated on a wide area of an electrode plate to increase the surface area of the active material and to increase a ratio of the active material contributing to electric energy.

The electrode plate having the active material coating is wound in a roll shape to reduce the size of a secondary battery. In some cases, a plurality of electrode plates are stacked in turns according to their polarities, and electrode plates having the same polarity are electrically connected, thereby providing a positive electrode and a negative electrode of a battery. Also, a separator may be interposed between the electrodes having different polarities to prevent an internal short circuit.

FIG. 1 is a partially expanded perspective view illustrating an electrode assembly assembled with a pouch in an exemplary pouch type lithium secondary battery.

Referring to FIG. 1, the pouch includes a lower part 20 having a hollow for containing the electrode assembly and an upper part 10 for covering the hollow. The pouch film is formed by stacking metallic foil 113 as an intermediate layer, and a thermal bonding type casted polypropylene (CPP) layer 111 and a nylon layer as inner and outer layers, respectively.

A typical electrode assembly 130 has a jelly roll configuration formed by winding a stack consisting of a negative electrode plate 131, a separator 133, and a positive electrode plate 135. The separator 133 is placed between the negative and positive electrode plates 131, 135 to prevent a short circuit between the positive electrode plate and the negative electrode plate.

In order to electrically connect the positive and negative electrode plates 131, 135 of the electrode assembly 130 to an outside of the pouch, electrode tabs 137, 138 are provided on one side of the positive electrode plate 131 and one side of the negative electrode plate 135, respectively. The electrode tabs 137, 138 are extended from the jelly roll configuration in a direction along the winding axis and via a sealing side of the pouch film. On a portion of the tabs 137, 138 overlapped with the pouch, a film 139 is attached for increasing a bond force between the tab and the pouch when the pouch is sealed.

However, in a typical electrode assembly, an electrode tab is installed in the center of the jelly roll configuration. In the pouch having a hollow 21 for containing the electrode assembly 130, a flange 23 for combining the upper part with the lower part of the pouch is provided around the opening of the hollow 21. Therefore, in order to extend the electrode tabs 137, 138 installed in the center of the electrode assembly outside of the pouch, the tabs 137, 138 may have to be bent inside the hollow 21, and their height may have to be adjusted to match the flange 23.

Furthermore, in order to bend the tabs 137, 138 in the inner space of the hollow 21, surplus room for containing the bent portions of the tabs may have to be provided. The room for the bent portions increases the difficulty in manufacturing of a battery having a small size and a high capacity. Also, the bent portions may be short circuited with the top portions of the electrode assembly or with the other tab, thereby causing battery errors or safety problems.

Such problems are common in secondary batteries having a jelly roll configuration type electrode assembly as well as a pouch type secondary battery having a hollow for containing the electrode assembly in the pouch. Accordingly, there is a need for a secondary battery having a jelly roll configuration type electrode assembly wherein a short circuit may be prevented between the tab and electrode plate and between the positive electrode tab and the negative electrode tab.

### SUMMARY OF THE INVENTION

A secondary battery is provided having a jelly roll configuration type electrode assembly capable of preventing the concentration of pressure caused by winding the jelly roll on a portion of the electrode plate overlapped with the tab in the jelly roll configuration type electrode assembly.

Also, an exemplary embodiment of the present invention provides a secondary battery having a jelly roll configuration type electrode assembly having a small size and a high capacity, in which excess space of the bare cell is reduced.

According to an exemplary embodiment of the present invention, a secondary battery is provided including: a jelly roll configuration type electrode assembly formed by winding a stack of two electrodes having different polarities and separators for preventing a short circuit between the two electrodes, a case for containing the electrode assembly, and electrode tabs for connecting the two electrodes of the electrode assembly to an outside of the case, wherein a level for extracting the electrode tabs from the electrode assembly is substantially equal to a level for extracting the electrode tabs from the case.

Both the electrode tabs may be extracted from the center of the jelly roll configuration type electrode assembly in parallel with each other in the same level, or on a different level, for example, an upper or lower portion of the electrode assembly. The difference between a level of an upper electrode tab and a level of a lower electrode tab may be within about ⅓ of a thickness of the electrode assembly. In other words, if the difference of the levels between both electrode tabs is within ⅓ of the thickness of the electrode assembly, it is possible to significantly reduce the possibility of bending the upper electrode tab or the lower electrode tab. If a pouch having a hollow is used, the electrode tabs should be connected to the electrode assembly in a level above the upper ⅓ of the thickness of the electrode assembly so as not to be bent in the inner space of the pouch until the electrode tabs are extracted from the pouch passing through the flange around the hollow.

In one exemplary embodiment, the difference of the level between the electrode tabs is within a range of 1/10 of the thickness of the electrode assembly. In this case, the electrode tabs are extended in a linear shape and extracted to extend outside of the case. Therefore, there is no need to bend the electrode tabs in an inner space of the case. Also, there is no need to provide surplus room for the bent electrode tabs in the pouch. For example, when both the electrode tabs are extracted from non-coating portions of the electrode, and both the electrode tabs are connected to an upper half of the thickness of the electrode assembly, the difference of the level between the upper electrode tab and the lower electrode tab may be with a range of 1/10 of the thickness of the electrode assembly.

In one exemplary embodiment, an electrode assembly of a secondary battery is a jelly roll configuration type having an elliptical shape or a track shape, and the electrode assembly is inserted into a polygonal case or a pouch having a hollow formed in only one side for containing the electrode assembly.

### BRIEF DESCRIPTION OF THE DRAWINGS

FIG. 1 is a partially exploded perspective view illustrating an electrode assembly assembled with a pouch in an exemplary pouch type lithium secondary battery.

FIG. 2 is a partially exploded perspective view illustrating a pouch type bare cell according to an embodiment of the present invention.

FIG. 3 is a plan view illustrating positions of electrode tabs in a jelly roll configuration type electrode assembly of a secondary battery according to an embodiment of the present invention.

FIG. 4 is a side sectional view of the electrode assembly mounted in the pouch according to an embodiment of the present invention.

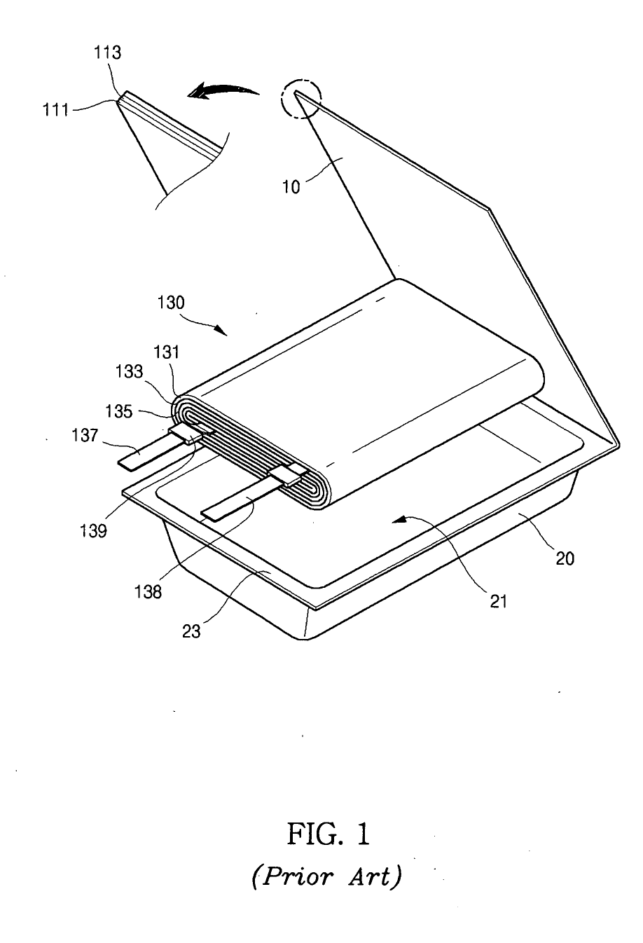

### DETAILED DESCRIPTION

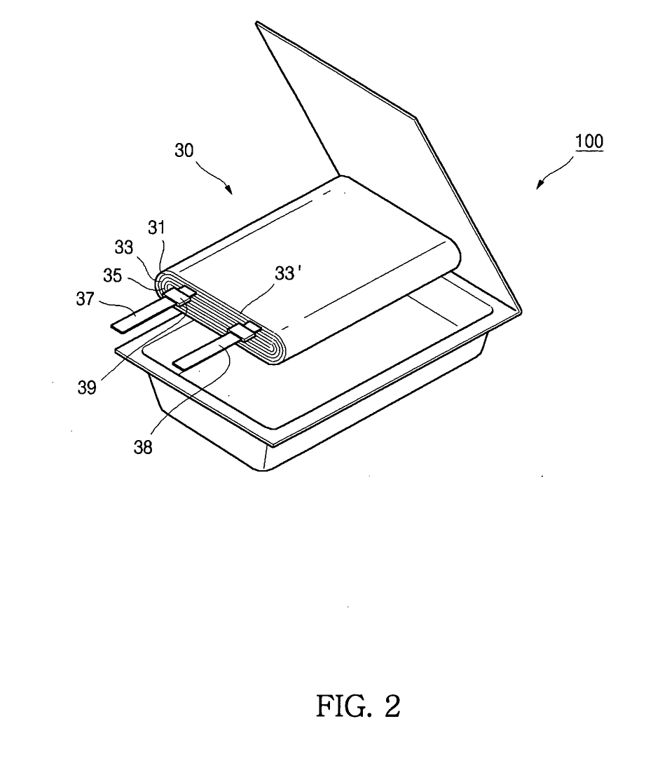

Referring to FIGS. 2, 3, and 4 a method of assembling a pouch type lithium secondary battery will be described. First, a lower part of the pouch 100 having a hollow for containing the electrode assembly and an upper part of the pouch for covering the lower part and the hollow are provided. The hollow may be formed by a press process. A hole (not shown) for discharging gases generated in a chemical reaction of a secondary battery is provided on a side surface of the hollow.

Similar to a typical electrode assembly 30, a separator 33′, a positive electrode plate 31, a separator 33, and a negative electrode plate 35 are stacked. Then, the stack is wound to provide a jelly roll configuration. Typically, the jelly roll configuration is formed to have an elliptical shape with a large eccentricity. The jelly roll configuration may be pressed in the direction of a short axis of the elliptical shape to provide a track-shaped cross-section. In this case, the negative and positive electrode tabs 37, 38 may be attached to non-coated areas of the negative and positive electrode plates 35, 31, respectively, by a welding process such as an ultrasonic welding.

In one exemplary embodiment, the separator may be made of a solid polymer also functioning as an electrolyte or an electrolyte infused gel type polymer. If the separator is made of a gel type polymer, the electrolyte is supplied to the electrode assembly to infuse the electrolyte into the polymer after forming a jelly roll configuration. Typically, the surface area of the separator is formed to be wider than that of the electrode plate to prevent a short circuit in the electrode plate.

Typically, the resin film 39 or the resin tape may be made from a thermal bonding material exhibiting a higher bond force with the tab made of metal compared to the inner surface of the pouch. A resin film 39 or a resin tape may be attached to portions of the tabs 37, 38 overlapped with the jelly roll configuration or the welding area of the pouch, i.e., the flange. The overlapped area forms a protruded step on which pressure is concentrated so that an irregular distribution of the electrolyte in this area may interfere with reaction of the electrode.

However, according to an exemplary embodiment of the present invention, the tabs are located at the same level as the outermost longitudinal side of the track type jelly roll configuration. Therefore, it is possible to prevent the negative electrode plate 35, the positive electrode plate. 31, and separators 33, 33′ from being overlapped with the tabs in the wound jelly roll configuration.

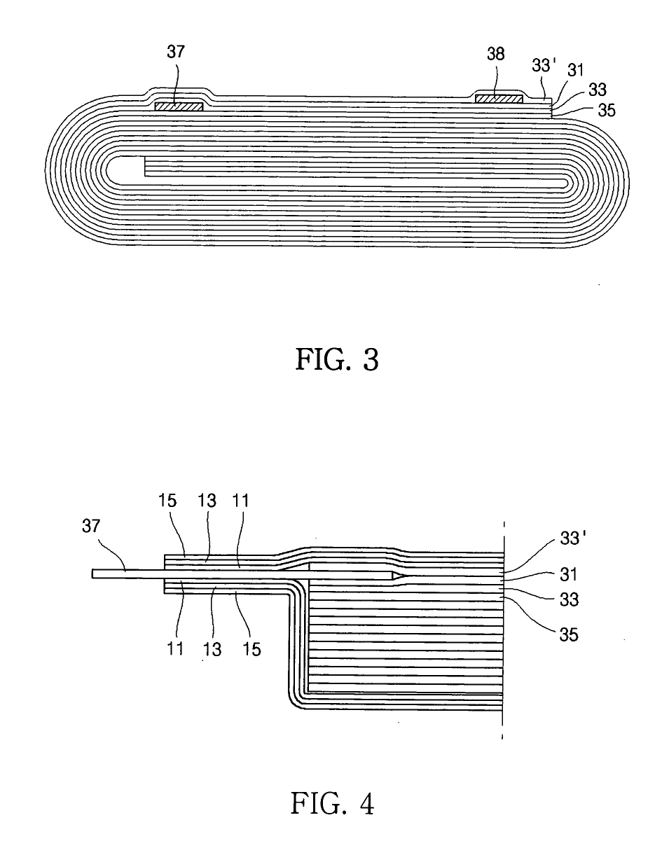

According to an exemplary embodiment of the present invention, as shown in FIG. 3, the electrode tabs are located in an upper 10% area of thickness of the electrode assembly when the electrode assembly is contained in the hollow of the pouch. Since the flange for sealing the pouch is located around the opening for the hollow from which the electrode tabs 37, 38 will extend, the electrode tabs are will extend out of the hollow at a position substantially equal to the level of the flange. Therefore, there is no need to bend the electrode tabs, but rather the electrode tabs may be extended from the pouch via the slot between the flange and the upper part.

There is also no need to provide surplus room for bending the electrode tabs in an inner space of the sealed pouch. That is, although FIG. 2 shows that the thermal bonding tape 39 of the electrode tabs 37, 38 is isolated far from the electrode plate of the jelly roll configuration, there is no need to position the jelly roll configuration far from the wall of the hollow of the pouch in practical cases. In addition, the film may make contact with the electrode plate of the jelly roll configuration.

As a result, the upper end of the jelly roll configuration may make contact with the wall of the hollow of the pouch, from which the electrode tabs are extended. Also, the lower end of the jelly roll configuration may make contact with the opposite wall of the hollow in the pouch. Thus, the jelly roll configuration is fit into the hollow without excess room in the pouch. Therefore, it is possible to have an improved battery capacity in the same volume of the pouch.

After sealing the pouch, accessories such as a protecting circuit module (PCM) and a positive temperature coefficient (PTC) device may be connected to the bare cell to provide a core pack. Then, a complete hard pack battery is provided by integrating the core pack into a hard case. The hard case may be formed by using a polypropylene resin without installing separate circuits or conductive materials.

Alternatively, separate accessories or conductive materials may be installed in the hard case depending on characteristics of the devices to be used by the corresponding battery.

One exemplary method for sealing the flange of the pouch well known to those skilled in the art includes pressing the flange at a temperature sufficiently high to melt the inner CPP layer of the pouch. The melted CPP layer of the upper and lower parts of the pouch are then cooled and solidified sealing the pouch and making a bond wrapping the tabs extruding from the electrode assembly and passing through the flange between the upper and lower parts of the pouch. Before sealing, the front portion of the flange where the tabs pass through may be flat without any recesses.

Yet, after pressing, the front portion of the flange may develop step-like indentations where the tabs pass through. As seen in FIG. 4, metallic foil 13 is layered between CPP layer 11, which acts as an adhesive layer or sealing material when it is heated, and nylon layer 15.

Though the embodiment shown in FIG. 2 has been described as a pouch having a hollow for containing the electrode assembly, the present invention may be applied to pouches or containers having different shapes, such as a polygonal shape, for containing the electrode assembly.

In a pouch having no separate hollow for containing the electrode assembly, the flanges are formed about in the middle of the thickness of the pouch. Therefore, the two electrode tabs extend from the electrode assembly about in the middle of the thickness of the pouch and extended linearly from the electrode assembly through the flanges.

In addition, when the jelly roll configuration type electrode assembly is contained in the polygonal case, the electrode tabs extend from a slot between the can and the longitudinal side of the cap plate which covers the opening of the polygonal can, or from a hole formed in the center of the cap assembly. In this case, if the polygonal case and the cap plate are made of a plastic material, it is not necessary to insert a resin film between the cap plate and the tab or between the tab and the polygonal case.

According to embodiments of the present invention, it is possible to decrease possibility of a short circuit between the electrode tabs and between the tab and the electrode plate in the bare cell of a jelly roll configuration type electrode assembly due to the locations of the electrode tabs.

In addition, it is possible to increase electrical capacity of the battery by reducing pressure concentrated on a portion of the electrode plate overlapped with the tabs in the jelly roll configuration type electrode assembly and facilitating reaction in the electrode plates.

Also, it is possible to provide a secondary battery with a jelly roll configuration type electrode assembly having a small size and a high capacity by reducing the space in the bare cell.

While exemplary embodiments of the present invention have has been particularly shown and described, it will be understood by those of ordinary skill in the art that various changes in form and details may be made therein without departing from the spirit and scope of the present invention as defined by the following claims.

What is claimed is:

1. A secondary battery comprising:
a jelly roll configuration type electrode assembly including a wound stack of two electrodes having different polarities and at least one separator for preventing a short circuit between the two electrodes,
a case for containing the jelly roll configuration type electrode assembly, and
electrode tabs for connecting the two electrodes to an outside of the case,
wherein a level at which the electrode tabs are extended from the electrode assembly is substantially equal to a level at which the electrode tabs are extended from the case.

2. The secondary battery according to claim 1, wherein the electrode tabs are extended from the electrode assembly at a level of ⅔ or more of a thickness of the electrode assembly.

3. The secondary battery according to claim 2,
wherein the electrode assembly is an elliptical shape, and
wherein the case for containing the electrode assembly is a pouch including a lower part having a hollow for containing the electrode assembly and an upper part having a cover for covering the hollow, the upper part being sealed to the lower part by bonding a flange formed around the hollow with the cover.

4. The secondary battery according to claim 3,
wherein the electrode assembly is inserted into the hollow with the electrode tabs being connected to an upper part of the electrode assembly, and
wherein the electrode tabs extend from the electrode assembly linearly between the sealed upper part and the lower part of the pouch.

5. The secondary battery according to claim 3, wherein an upper side of the electrode assembly from which the electrode tabs are extended contacts a wall of the pouch facing the upper side of the electrode assembly such that there is substantially no space between them.

6. The secondary battery according to claim 3, wherein the pouch is formed by stacking a nylon layer onto a first side of an aluminum foil and a casted polypropylene layer inside a second side of the aluminum foil.

7. The secondary battery according to claim 1, wherein the electrode tabs are extended from the electrode assembly in about 9/10 or greater level of a thickness of the electrode assembly, and connected to non-coating portions of the electrodes.

8. The secondary battery according to claim 1, wherein a resin film is interposed between the case and the electrode tabs for sealing portions where the electrode tabs contact the case when the electrode tabs are extended from the case.

9. The secondary battery according to claim 8, wherein the resin film is made of an adhesive material having higher adhesion characteristics to metal than material of an inner surface of the case.

10. The secondary battery according to claim 1, wherein the separator is made of a solid polymer functioning as an electrolyte or an electrolyte infused gel type polymer.

11. The secondary battery according to claim 1, wherein the electrode assembly is contained in a polygonal plastic case, and the electrode tabs are extended from a slot between the case and a longitudinal side of a plastic cap assembly.

12. A method for extending electrode tabs from an electrode assembly located in a pouch of a secondary battery, the method comprising:
providing the pouch having a hollow for housing the electrode assembly and a flange protruding from the hollow at a first level; and
providing the electrode assembly having electrode tabs protruding linearly from the pouch at substantially the first level.

13. The method of claim 12, wherein the electrode tabs are extended from the electrode assembly at a level of ⅔ or more of a thickness of the electrode assembly.

14. The method of claim 12, wherein the pouch includes an upper part having a cover for covering the hollow.

15. The method of claim 14, further comprising sealing the upper part to the flange.

16. The method of claim 14, wherein there is substantially no space between the flange and the cover.

17. The method of claim 12, wherein the pouch is formed by stacking a nylon layer onto a first side of an aluminum foil and a casted polypropylene layer inside a second side of aluminum foil.

18. The method of claim 12, wherein the electrode tabs are extended from the electrode assembly in about 9/10 or greater level of a thickness of the electrode assembly.

19. The method of claim 12, further providing a resin film between the pouch and the electrode tabs for sealing portions where the electrode tabs contact the pouch.
